(19) United States
(12) Patent Application Publication
(10) Pub. No.: US 2003/0205207 A1
(43) Pub. Date: Nov. 6, 2003

(54) Method of controlling and reducing food intake for a dog

(75) Inventors: Les R. Sherrill, Kailua, HI (US); Laura Sherrill, Kailua, HI (US); Peter B. Wheeler, Honolulu, HI (US)

Correspondence Address: BANNER & WITCOFF, LTD., TEN SOUTH WACKER DRIVE, SUITE 3000, CHICAGO, IL, 60606, US

(73) Assignee: Dingo Brand, LLC., Aiea, HI

(21) Appl. No.: 10/465,002

(22) Filed: Jun. 19, 2003

Related U.S. Application Data
(63) Continuation-in-part of application No. 09/874,353, filed on Jun. 6, 2001.

(51) Int. Cl. A01K 29/00

(52) U.S. Cl. 119/710

(57) ABSTRACT

This invention relates to a method of using meal alternatives and diet methods to maintain and enhance an animal's health, particularly a dog. Obese dogs face a higher risk of many different ailments and a shorter lifespan. An animal chew meal alternative fortified with health affecting additives is safe, entertaining, and promotes good health. The invention enhances a dog's diet by substituting a healthy, high protein, palatable meal alternative of known caloric content for daily treats and table scraps of unknown caloric content that can result in reduced caloric intake. In addition, a collaborative exercise regimen for the dog and the dog's owner further improves health and wellness of the pet. Overall, the invention reduces the time required by a pet owner to administer a healthy, satisfying diet for his pet.

The present application is a continuation-in-part of U.S. patent application Ser. No. 09/874,353, filed Jun. 6, 2001, the entire disclosure of which is hereby incorporated by reference.

### FIELD OF THE INVENTION

The invention relates to animal nutrition. More particularly, this invention relates to the use of meal alternatives and diet methods to maintain and enhance an animal's health.

### BACKGROUND

Carnivorous animals, primarily domesticated dogs, have nutrient requirements essential to good health. A dog's good health depends on the well-balanced intake of six required groups: water, protein, fat, carbohydrates, minerals, and vitamins. Some sources of nutrition are healthier than others. For example, a dog can consume its required nutrients from commercially purchased pet foods as well as human table scraps. Although dogs enjoy table scraps, ideally they should not be fed to a dog because table scraps do not always provide a balanced diet and they vary considerably in the quantity and quality of calories within.

Furthermore, a dog's daily food intake including commercial dog food, table scraps and treats, contribute to the dog's total consumption of calories. If these calories are not regulated, it can lead to an obese and overweight dog. Research shows that twenty-five to forty percent of all dogs are overweight. Obesity can lead to negative health effects, such as an increased risk of heart disease, diabetes, osteoarthritis, and a potentially shortened life span. The causes of obesity generally fall into three categories: inappropriate diet, genetic predisposition, and hormonal disorder. Obesity caused by an inappropriate diet results when the dog's caloric intake exceeds the dog's caloric expenditure. There are two ways to impact the dog's weight: feed the dog fewer calories, and increase the amount of exercise. The most common methods to decrease food intake calories is to reduce regular food quantity or to substitute with a similar quantity of a low-fat diet dog food, as diet dog foods are generally of low palatability to a dog, both methods lead to low satisfaction for both a dog and a dog's owner.

Core components of most weight reduction programs require strict adherence to calorie counting, dividing caloric intake into smaller multiple meals throughout a day as well as a regular exercise regimen. Obviously a dogs food intake is usually the responsibility of and controlled by, the dog owner, dogs are not overweight because they eat too much but because they are fed too much. However, typically a dog owner does not have an excessive amount of time available to regulate a dog's diet and reducing a dog's food intake can leave a dog owner feeling unsatisfied about depriving their dog. In addition the habit of feeding table scraps is partly the result of not having a disciplined alternative that provides the same level of satisfaction.

Accordingly, there is a need in the art for pet diet methods that enhances a pet's health while minimizing the amount of time required by pet owners to administer the meal alternative, and while maximizing a pet and it's owner's satisfaction.

### BRIEF SUMMARY

One or more of the disadvantages of the prior art are overcome by the disclosed meal alternatives and diet methods. A chew meal alternative is provided to a carnivorous animal, such as a dog. The meal alternative may be used as a substitute for conventional dog food meals. The meal alternative may be used to control caloric intake and improve the animal's health. An exercise program may be used in connection with the meal alternative.

In a first embodiment of the invention, a method of improving and maintaining a pet's health is provided. At least one daily food intake of the pet is substituted with at least one meal alternative. The quantity of meal alternative to deliver to the pet is also determined. The determination may be based on information from a chart and a veterinarian's opinion.

In a second embodiment of the invention, a method of improving and maintaining a pet's health is provided where exactly two daily food intakes of the pet are substituted with at least one meal alternative. The quantity of meal alternative to deliver to the pet is also determined. The determination may be based on information from a chart and a veterinarian's opinion.

In a third embodiment of the invention, a method of providing a nutritional program for a pet is provided. A plurality of chew meal alternatives and a chart that recommends the number of chew meal alternative to administer to the pet to enhance a pet's health are provided.

### BRIEF DESCRIPTION OF THE DRAWINGS

The present invention is illustrated by way of example and not limited in the accompanying figures in which like reference numerals indicate similar elements and in which:

FIG. 1 is a top perspective view of a chew including an elongate member containing interspersed flavor chunks, in accordance with an embodiment of the invention; and

FIG. 2 illustrates a method of using a meal alternative to improve the health of a pet in accordance with an embodiment of the invention.

FIG. 3 illustrates a method of providing a nutritional program to improve the health of a pet in accordance with an embodiment of the invention.

### DETAILED DESCRIPTION

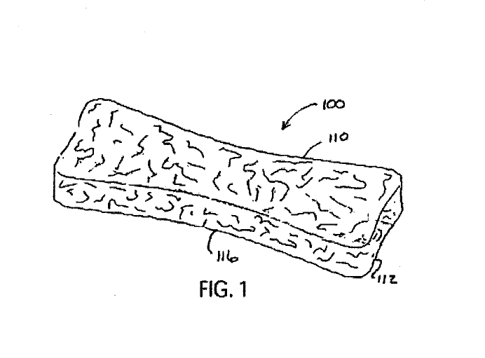

FIG. 1 shows a chew meal alternative in accordance with an embodiment of the invention. One embodiment of a meal alternative in the subject invention is referred to as a “chew.” A “chew” may be in the form of a toy. The chew may also be part of a therapeutic device, a medicinal conveyance device, a dental hygiene device, or a meal alternative. A preferred shape of the chew takes a form of a bone shape. In such a configuration, a chew 100 preferably has a first end portion 112 and an opposed second end portion. In between the end portions 112 and the opposed second end portion is a center or middle portion 116. The middle portion 116 may be narrower in cross-sectional area than the end portions. These features, in combination with its elongated proportions, may assist the chew 100 in simulating the bone shape. The body 110 of the present invention is preferably comprised of a granulate rawhide paste. “Granulate rawhide” generally refers to rawhide that is cut or ground in to bits or pieces. The granulate rawhide with adherent is referred to as a “rawhide mixture”. The rawhide mixture may include additives, such as coloring, flavor, vitamins, minerals, nutrients, or any other health affecting matter such as the ingredients as described hereinafter.

A chew comprises a rawhide composition and one or more flavor pieces. The rawhide need not be explicitly ‘raw’ and may have some treatment not deleterious to carnivorous animals, particularly dogs. The distinct flavor piece or pieces may be chunks of flavor and is most preferably, but not limited to jerky. Jerky is an extremely appetizing treat for dogs, and the taste of the jerky constantly entices and satisfies dogs.

It should be noted that the term “jerky” as used herein is defined as including, but not limited to, “traditional jerky” and “kippered jerky.” “Traditional jerky” as defined herein typically consists of beef, lamb, pork, fish, poultry including chicken and turkey, and/or any other animal flesh, which is cut into strips. The strips of meat may be flavored using spices and/or marinade, and dried via a smoker or another manner. “Kippered jerky” as defined herein includes pieces of meat, such as, beef, lamb, pork, fish, poultry including chicken and turkey, and/or any other animal meat, which is mixed together with spices and/or fillers. The mixture is forced through a sausage press (with or without a casing) and is typically formed flat rather than cylindrical. The flat product may then be smoke dried and/or dried in another manner.

Health affecting additives may be included in the rawhide mixture. For example, one or more additives, such as, vitamins (e.g., vitamin C), minerals, glycerin (a sweetener), seaweed, algae (e.g., Spirulina), wheat germ (a coat improving additive), glucosamine, antioxidants, medicine and/or other health affecting matter. These additional ingredients may also be incorporated into the mixtures for the embodiment of FIG. 1. The chew used by the present invention may serve as a vehicle for administering certain health affecting matter in the rawhide mixture or in the flavor member or flavor chunks.

It will be appreciated that shapes and sizes other than bone shapes are contemplated. For example, the chew can be spherical, elliptical, cylindrical, rectangular, square, or any desired shape or cross-section. It is appreciated that a bone or stick shape may be preferred by customers purchasing a meal alternative since it is most readily identified by dogs, and therefore, dogs are more likely to enjoy it. Dogs may get more excited and obtain more pleasure from receiving a bone or stick shape that they can grab in their mouth and walk around with. In addition, unlike a treat or dog kibble that is lost in the mouth and swallowed, a dog gets greater satisfaction from chewing and consuming a dog chew meal alternative.

Since chewing rawhide products for extended periods of time tends to reduce plaque and tartar on dogs' teeth, the chew used by the present invention can provide enhanced reduction of plaque and tartar because dogs will tend to gnaw on the present chew for a noticeable periods of time. This will result in enhanced health benefits for dogs.

Furthermore, dog owners may be busy and find it difficult to follow a diet plan for their pet. In one embodiment, the meal alternative is packaged in multi-units of a predetermined quantity making it convenient for the dog owner to distribute food intake servings. Therefore, reducing the amount of time required to perform the method of producing food intake for a dog.

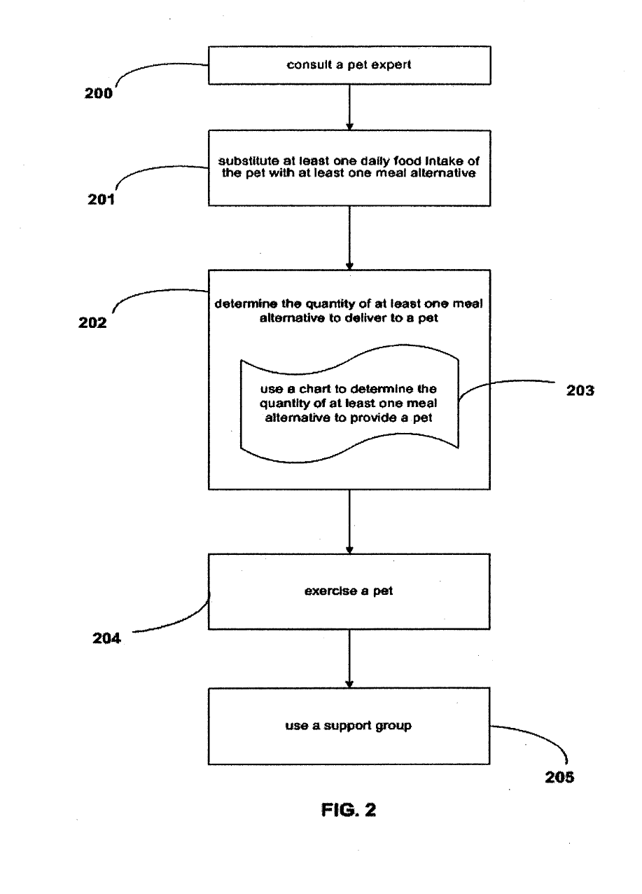

FIG. 2 illustrates a method of providing proper nutrition to a pet in accordance with an embodiment of the invention. The method of FIG. 2 works particularly well with carnivorous animals, such as dogs. In step 201, at least one daily food intake of the pet is substituted with at least one meal alternative. In one embodiment, the meal alternative is a chew. Additionally, at least one daily food intake will not be a meal alternative. Instead, it will be a sensible serving of food, particularly dog food. For example, a dog owner that feeds his dog twice a day would substitute one meal with a chew meal alternative, and serve a sensible, balanced meal for the other food intake. In another embodiment, a dog owner that feeds his dog three times a day would substitute two regular meals with two chew meal alternatives, and serve a sensible, balanced meal for the remaining food intake. The sensible, balanced meal may be commercial dog food, veterinarian prescribed prepared meals, or any other form of nutritious intake.

An aspect of the invention recognizes that a dog does not become overweight simply because it over-eats, but because it is overfed. Therefore, training the caretaker that feeds the dog is important to a diet method. In step 202, a caretaker with a busy schedule can conveniently obtain information contained in a chart 203 to determine the quantity of meal alternative chew to deliver to the pet. In one embodiment, the information in the chart includes recommended daily caloric content for different breeds of dogs. Some factors, such as a dog's frame size, age, weight or breed, can be used as parameters in determining the optimal, recommended daily caloric content. In other embodiments, the chart may contain recommended serving quantities of a particular brand of product, type of product or a particular dog. The recommended daily caloric and/or nutritional content may be in the form of a number of chew meal alternatives. For example, the chart may indicate that a particular breed of dog having a given weight should be fed two chew meal alternatives daily in addition to a sensible, balanced meal to obtain optimal caloric intake. In addition, the chew meal alternatives are of known caloric content, therefore, allowing a pet owner to easily and quickly ascertain a pet's total daily caloric intake. Prior to performing steps 201 and 202, in step 200, a pet expert, for example a veterinarian, should be consulted for advice and guidance specific to the pet.

Furthermore, the pet is exercised in step 204. Embodiments of the exercise can be comprised of such activities as walking a dog, or throwing an object for the dog to retrieve. In addition, people are more effective at losing and maintaining weight loss success when they do it with a friend or companion. Therefore, another embodiment of the exercise program may be a collaborative exercise regimen for a dog and a dog's caretaker. In one embodiment, the caretaker may be the dog's owner.

Finally, in step 205, a support group may be used to ask a pet expert questions, discuss health concerns, and get advice to maximize a pet's health. In one embodiment, the support group may communicate on-line, i.e., over the internet. A list of frequently asked questions may also be made available online for the support group. An on-line support group may also provide the ability to monitor case histories, collect success and failure stories, and allow communication between support group members using bulletin boards and chat rooms.

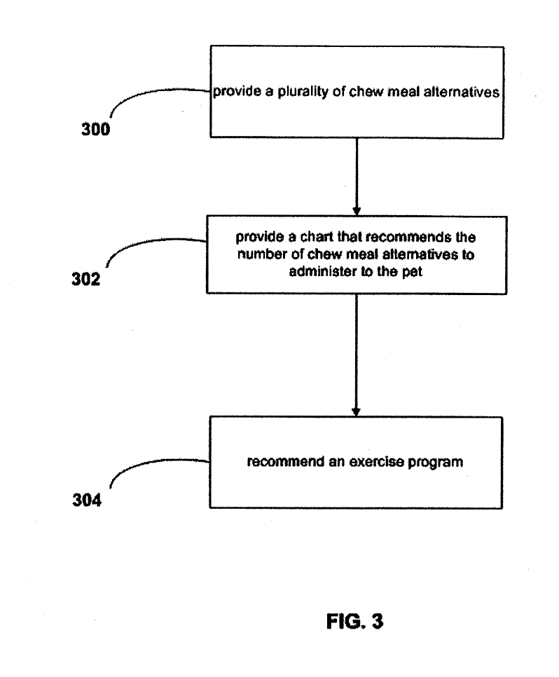

FIG. 3 illustrates a method of providing proper nutrition to a pet in accordance with an embodiment of the invention. The method of FIG. 3 works particularly well with carnivorous animals, such as dogs. First, in step 300, a plurality of chew meal alternatives are provided. In one embodiment, the chew meal alternatives may be packaged in multi-units of a predetermined quantity. Next, in step 302, a chart is provided that recommends the number of chew meal alternative to administer to the pet according to the optimal, recommended caloric intake for the pet.

In one embodiment, the chart may include the identification of different breeds of dogs and corresponding recommended number of meal alternatives. In another embodiment, the chart may include the identification of different weights of dogs and corresponding recommended number of meal alternatives. Other factors, such as a dog's frame size, age, weight or breed, can be used as parameters in determining the recommended daily caloric content. In other embodiments, the chart may contain recommended serving quantities of a particular brand of product, type of product or a particular dog. The recommended daily caloric and/or nutritional content may be in the form of a number of chew meal alternatives. For example, the chart may indicate that a particular breed of dog having a given weight should be fed four chew meal alternatives daily.

Furthermore, an exercise program is recommended for a pet in step 304. Embodiments of the exercise can be comprised of such activities as walking a pet, or throwing an object for a pet to retrieve. In addition, people are more effective at losing and maintaining weight loss success when they do it with a friend or companion. In one embodiment, a collaborative exercise regimen for pets and a pet's caretaker is provided.

While particular embodiments of the invention have been shown and described, it is recognized that various modifications thereof will occur to those skilled in the art. For example, it is possible to exercise a pet in numerous ways, including by walking the pet or by throwing an object for the pet to retrieve. Therefore, the scope of the herein-described invention shall be limited solely by the claims appended hereto.

We claim:

1. A method of delivering proper nutrition to a pet that reduces the amount of time required by a pet caretaker to administer food intake to a pet each day, the method comprising:
(a) substituting at least one daily food intake of the pet with at least one meal alternative; and
(b) determining the quantity of said at least one meal alternative to deliver to the pet.

2. The method of claim 1, wherein said at least one meal alternative comprises a chew of known quantifiable caloric content containing a health affecting additive.

3. The method of claim 2, wherein said chew comprises a composite of animal hide bits and discrete pieces of flavor product interspersed in the composite.

4. The method of claim 2, wherein said chew is available in a plurality of shapes.

5. The method of claim 2, wherein said chew is packaged in multi-units of a predetermined quantity.

6. The method of claim 2, wherein said pet is a carnivorous animal.

7. The method of claim 2, wherein the pet is a dog.

8. The method of claim 1, wherein step (b) comprises using a chart to determine the quantity of said at least one meal alternative to provide said pet.

9. The method of claim 8, wherein said chart indicates the number of meal alternatives recommended for proper nutrition and caloric intake.

10. The method of claim 8, wherein said chart indicates a quantity of caloric content from said meal alternatives recommended to reduce weight in obese pets.

11. The method of claim 8, wherein said chart indicates a quantity of caloric content from said meal alternatives recommended for proper nutrition and weight maintenance.

12. The method of claim 9, wherein said at least one meal alternative comprises a nutritionally balanced chew containing a health affecting additive.

13. The method of claim 12, wherein said chew comprises a composite of animal hide bits and discrete pieces of flavor product interspersed in the composite.

14. The method of claim 12, wherein said pet is a dog.

15. The method of claim 8, further comprising:
(c) exercising said pet.

16. The method of claim 15, further comprising:
(d) first consulting a pet expert.

17. The method of claim 16, further comprising:
(e) consulting a support group.

18. The method of claim 17, wherein said support group is on-line and used to discuss issues concerning a pet's health.

19. A method providing a nutritional program for a pet, the method comprising:
(a) providing a plurality of chew meal alternatives; and
(b) providing a chart that recommends the number of chew meal alternatives to administer to the pet to provide proper nutrition.

20. The method of claim 19, wherein the chart includes the identification of different breeds of dogs and corresponding recommended numbers of meal alternatives.

21. The method of claim 19, wherein the chart includes the identification of different weights of dogs and corresponding recommended number of meal alternatives.

22. The method of claim 19, wherein said chew meal alternatives are packaged in multi-units of a predetermined quantity.

23. The method of claim 19, further comprising:
(c) recommending an exercise program.

24. The method of claim 23, wherein the exercise program comprises a collaborative exercise regimen.

25. The method of claim 19, wherein the pet is a carnivorous animal.

26. The method of claim 25, wherein the pet is a dog.
